(19) United States
(12) Patent Application Publication
(10) Pub. No.: US 2026/0235092 A1
(43) Pub. Date: Aug. 13, 2026

(54) GASEOUS FUEL ENGINE AND OPERATING STRATEGY FORMING GASEOUS FUEL CHARGE FROM MULTIPLE INJECTIONS

(71) Applicant: Caterpillar Inc., Peoria, IL (US)

(72) Inventors: Bobby John, Peoria, IL (US); Jonathan William Anders, Peoria, IL (US)

(73) Assignee: Caterpillar Inc., Peoria, IL (US)

(21) Appl. No.: 19/047,916

(22) Filed: Feb. 7, 2025

(51) Int. Cl. F02M 21/02

(52) U.S. Cl. CPC F02M 21/0206; F02M 21/0248; F02M 21/0284

(57) ABSTRACT

A gaseous fuel engine system includes an engine having a cylinder head, and an intake valve movable between a closed position and an open position to fluidly connect an intake conduit to a cylinder in the engine. The intake conduit may include a divided intake conduit forming a first intake port and a second intake port. The engine system also includes a fuel system including a gaseous fuel supply containing a gaseous fuel such as a gaseous hydrogen fuel, and an injection control unit structured to energize a first injector and to energize a second injector to inject gaseous fuel into the intake conduit, and cause, based on the energizing, formation of a gaseous fuel charge in the cylinder at a timing between an intake valve opening timing and an intake valve closing timing.

### TECHNICAL FIELD

The present disclosure relates generally to operating a gaseous fuel engine system, and more particularly to forming a gaseous fuel charge in a cylinder from multiple injections prior to an intake valve closing timing.

### BACKGROUND

Internal combustion engines are well-known and widely used throughout the world for diverse purposes ranging from vehicle propulsion to operation of pumps and compressors and production of electrical power. A fuel is admitted into one or more cylinders of an engine and ignited to produce a controlled combustion reaction that drives a piston coupled to a crankshaft. All manner of fuel types and operating strategies have been utilized for well over a century.

In recent decades, increased regulatory and commercial attention has been given to reduction of certain emissions from conventional internal combustion engines. Liquid fuel engines operating on petroleum distillate fuels remain in widespread use and will likely remain so for the foreseeable future. Petroleum distillate fuels nevertheless can produce undesired amounts of oxides of nitrogen, particulate matter, and so-called greenhouse gases. Gaseous fuel engines utilizing, for example, natural gas can address some of these concerns particularly with regard to particulate emissions, but nevertheless can produce NOx, carbon dioxide, and carbon monoxide.

In an effort to further refine and manipulate emissions profiles of internal combustion engines, the use of gaseous hydrogen fuel as a primary fuel or a supplement to other gaseous fuels has been the subject of significant engineering efforts in recent years. Gaseous hydrogen fuel offers the promise of minimal undesired emissions. Hydrogen has a relatively low flammability limit, however, and a relatively fast flame speed in situ. For this reason, manufacturers have encountered numerous technical obstacles to successful implementation of gaseous hydrogen fuels, particularly in reciprocating piston engines. One example of a gaseous fuel engine having at least some capacity for operating on hydrogen is known from International Patent Application No. WO2014053167A1.

### SUMMARY

In one aspect, a gaseous fuel engine system includes an engine having a cylinder block forming a cylinder, a cylinder head forming an exhaust conduit, and an intake conduit for receiving a feed of pressurized air, and an intake valve movable from a closed position at an intake valve opening timing (IVO), and to the closed position at an intake valve closing timing (IVC). The engine system further includes a fuel system having a gaseous fuel supply containing a gaseous fuel, a first injector coupled to the intake conduit, and a second injector coupled to the intake conduit. The gaseous fuel engine system further includes an injection control unit structured to energize the first injector and to energize the second injector to inject a first injection and a second injection, respectively, of a gaseous fuel into the intake conduit. The injection control unit is further structured to cause, based on the energizing of the first injector and the energizing of the second injector, the first injection and the second injection to form a gaseous fuel charge in the cylinder at a timing between the IVO and the IVC.

In another aspect, a method of operating an engine includes moving an intake valve in an engine from a closed position to an open position to fluidly connect a cylinder in the engine to an intake conduit feeding pressurized intake air. The method further includes injecting a gaseous fuel into the intake conduit in a first injection from a first injector, injecting a gaseous fuel into the intake conduit in a second injection from a second injector, and admitting the gaseous fuel of the first injection and the gaseous fuel of the second injection from the intake conduit into the cylinder. The method still further includes forming a gaseous fuel charge of the admitting gaseous fuel in the cylinder between an intake valve opening timing and an intake valve closing timing, and combusting the gaseous fuel charge in the cylinder.

In still another aspect, a cylinder head assembly for a gaseous fuel engine includes a cylinder head forming a plurality of exhaust conduits, a plurality of intake conduits, and a common air admission cavity arranged to feed pressurized air to the plurality of intake conduits. At least one of the plurality of intake conduits includes a divided intake conduit forming a first intake port and a second intake port together arranged to feed the pressurized air to one of the plurality of cylinders in a gaseous fuel engine. The cylinder head assembly further includes a first intake valve and a second intake valve supported in the cylinder head and arranged to open and close, respectively, the first intake port and the second intake port, and a first injector and a second injector supported in the cylinder head and arranged to inject a gaseous fuel into the first intake port and the second intake port, respectively.

### BRIEF DESCRIPTION OF DRAWINGS

FIG. 1 is a diagrammatic view of a gaseous fuel engine system, according to one embodiment;

FIG. 2 is a sectioned view through a cylinder head assembly, according to one embodiment;

FIG. 3 is a sectioned side diagrammatic view through the cylinder head assembly as in FIG. 2;

FIG. 4 is another sectioned side diagrammatic view through the cylinder head assembly as in FIG. 2; and

FIG. 5 is a graph illustrating engine events and gaseous fuel charge formation, according to one embodiment.

### DETAILED DESCRIPTION

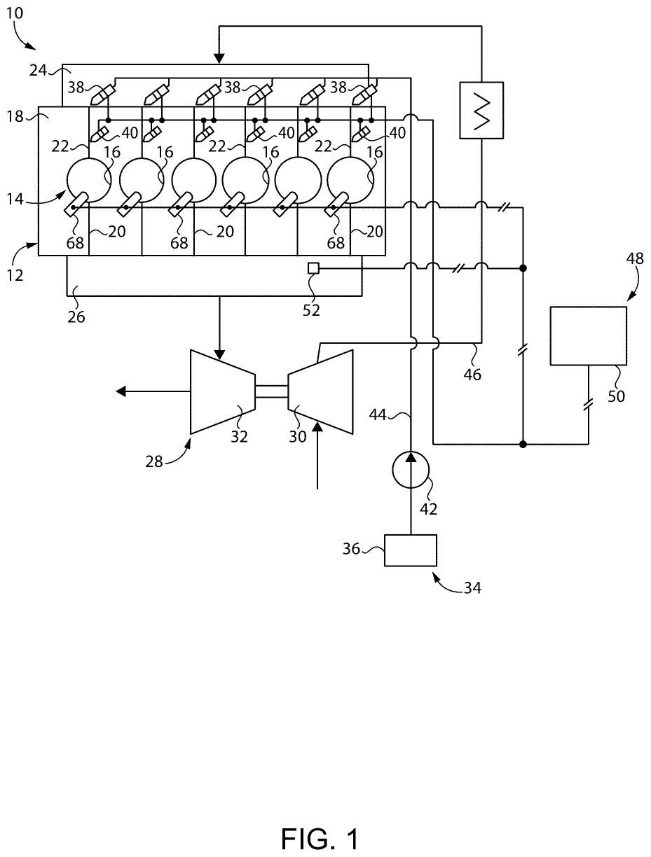

Referring to FIG. 1, there is shown a gaseous fuel engine system 10, according to one embodiment. Engine system 10 includes a gaseous fuel engine 12 having a cylinder block 14 forming a cylinder 16, and a cylinder head 18 forming an exhaust conduit 20, and an intake conduit 22 for receiving a feed of pressurized intake air. In the illustrated embodiment, cylinder block 14 has a plurality of cylinders 16 formed therein, and cylinder head 18 forms a plurality of exhaust conduits 20 and a plurality of intake conduits 22, details and functionality of which are further discussed herein. Description and discussion herein of any one element in the singular should be understood to refer by way of analogy to any like elements as may be included in engine system 10. Thus, reference to one cylinder refers to any other cylinders, reference to one intake valve refers to any other intake valves, and so on, except where otherwise indicated or apparent from the context.

Engine 12 further includes an intake manifold 24, and an exhaust manifold 26. Intake manifold 24 may be an integrated part of cylinder head 18 in some embodiments, as further discussed herein. Engine system 10 further includes a turbocharger 28 having a compressor 30 and a turbine 32. Turbocharger 28 may be operable in a generally conventional manner. Cylinders 16 can include any number, including one, arranged in any suitable configuration such as a V-pattern, an in-line pattern, or still another. Engine system 10 can be implemented in any application, such as operating a driveline in a land vehicle or a marine vessel, operating a pump, a compressor, or an electrical generator to name a few examples.

Engine system 10 also includes a fuel system 34. Fuel system 34 includes a gaseous fuel supply 36 containing a gaseous fuel. A gaseous fuel used in engine system 10 may be a gaseous hydrogen fuel, such as gaseous molecular hydrogen, a gaseous hydrocarbon fuel such as methane, ethane, or natural gas, or various blends of these or still others. A gaseous hydrogen fuel as contemplated herein includes gaseous molecular hydrogen or a blend where gaseous molecular hydrogen predominates by volume. Variable fuel blend ratios adjusted during operating engine system 10 are within the scope of the present disclosure.

Fuel system 34 also includes a first injector 38 coupled to intake conduit 22, at a first fuel admission location, and a second injector 40 coupled to intake conduit 22, at a second fuel admission location. Each one of the plurality of cylinders 16 and the plurality of intake conduits 22 may be associated with a first injector 38 and a second injector 40. First injector 38 and second injector 40 may be electrically actuated, such as solenoid actuated. Thus, energizing first injector 38 and second injector 40 actuates the respective injectors to cause injection of a gaseous fuel, as also further discussed herein. In a practical implementation, engine 12 is spark-ignited and includes a plurality of sparkplugs 68 each forming a spark gap within or in fluid communication with a respective cylinder 16. Sparkplugs 68 can include open sparkplugs, prechamber sparkplugs, or prechamber ignition devices having dedicated supplies of an ignition fuel.

Fuel system 34 also includes a fuel pump 42 structured to feed fuel from fuel supply 36 through a fuel supply conduit 44 to fuel injectors 38 and 40. An air feed conduit 46 extends between compressor 30 and intake manifold 24 to provide a feed of pressurized intake air. Engine system 10 also includes a control system 48. Control system 48 includes an injection control unit 50, including any suitable computerized control unit having one or more data processors and one or more computer readable memories, in control communication with first injector 38 and second injector 40. Control system 48 also includes an engine timing sensor 52, such as a crank angle timing sensor, structured to output a timing signal to injection control unit 50 for energizing first injector 38 and second injector 40 at appropriate injection timings as further discussed herein.

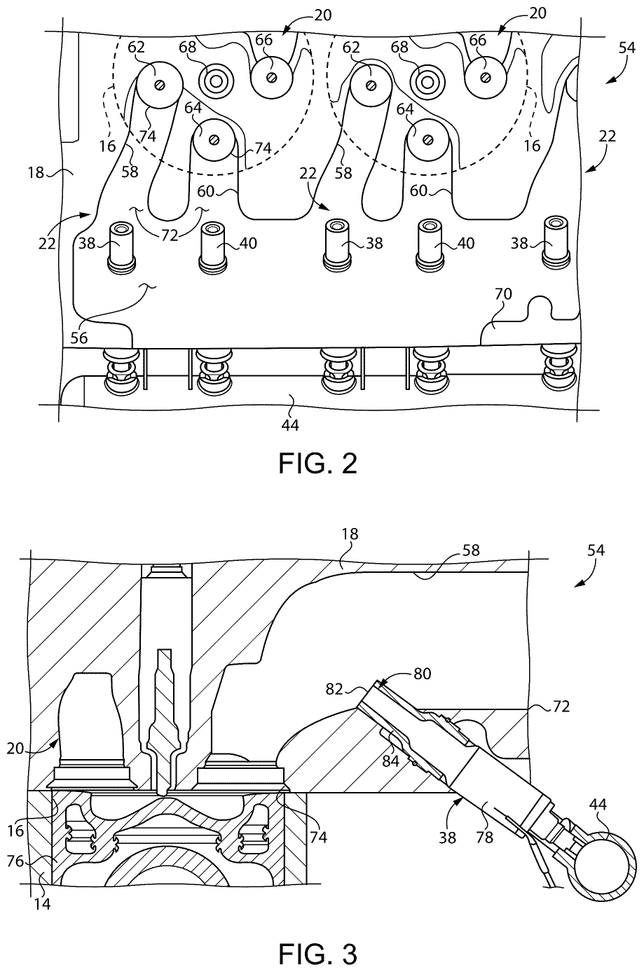

Referring also now to FIG. 2, there are shown features of engine system 10 in further detail and including a cylinder head assembly 54. Cylinder head assembly 54 includes cylinder head 18. As suggested above, cylinder head 18 may include intake manifold 24 as an integrated component thereof. Cylinder head 18 forms a common air admission cavity 56 arranged to feed pressurized intake air to the respective plurality of intake conduits 22. Air admission cavity 56 receives the feed of pressurized intake air by way of an air admission opening 70. Also in the illustrated embodiment, at least one and typically all of the respective intake conduits 22 include a divided intake conduit forming two intake ports including a first intake port 58 and a second intake port 60 together arranged to feed the pressurized intake air to one of cylinders 16.

Each of intake ports 58 and 60 forms an upstream port feed opening 72 to receive the incoming flow of air and convey the same to a downstream intake opening 74 that fluidly connects to the subject cylinder 16. Cylinder head assembly 54 also includes a first intake valve 62 and a second intake valve 64 supported therein, typically a plurality of first intake valves and a plurality of second intake valves, arranged in pairs to open and close, respectively, first intake port 58 and second intake port 60 to each cylinder. First injector 38 and second injector 40 are also supported in cylinder head 18 and arranged to inject gaseous fuel directly into first intake port 58 and second intake port 60, respectively. From the foregoing description it will be appreciated that each cylinder 16 is associated with an intake conduit 22 that may be a divided intake conduit forming two intake ports 58 and 60. Each cylinder 16 may also be associated with an exhaust conduit 20, including an exhaust valve 66 positioned therein. Each exhaust valve 66 will typically be one of two analogous exhaust valves for each respective cylinder 16.

Referring also now to FIG. 3, there is shown another view of cylinder head assembly 54 attached to cylinder block 14. A piston 76 is positioned in cylinder 16 and movable between a top-dead-center position and a bottom-dead-center position in a generally conventional manner, typically in a four-stroke engine cycle. Piston 76 may be equipped with a combustion bowl in some embodiments. Also shown in FIG. 3 is first injector 38 fluidly connected to fuel supply conduit 44 and extending into first intake port 58. First injector 38 may include an injector body 78 positioned at least partially in an injector sleeve 84. First injector 38 also includes a nozzle 80 forming an outlet 82 for injection of gaseous fuel into first intake port 58. It will be appreciated that first injector 38 may be oriented so as to inject the gaseous fuel generally in a downstream direction with the feed of incoming pressurized air. An orientation of first injector 38, and analogously second injector 40, might be about 15 degrees to a horizontal plane defined by the respective intake port surfaces in some embodiments.

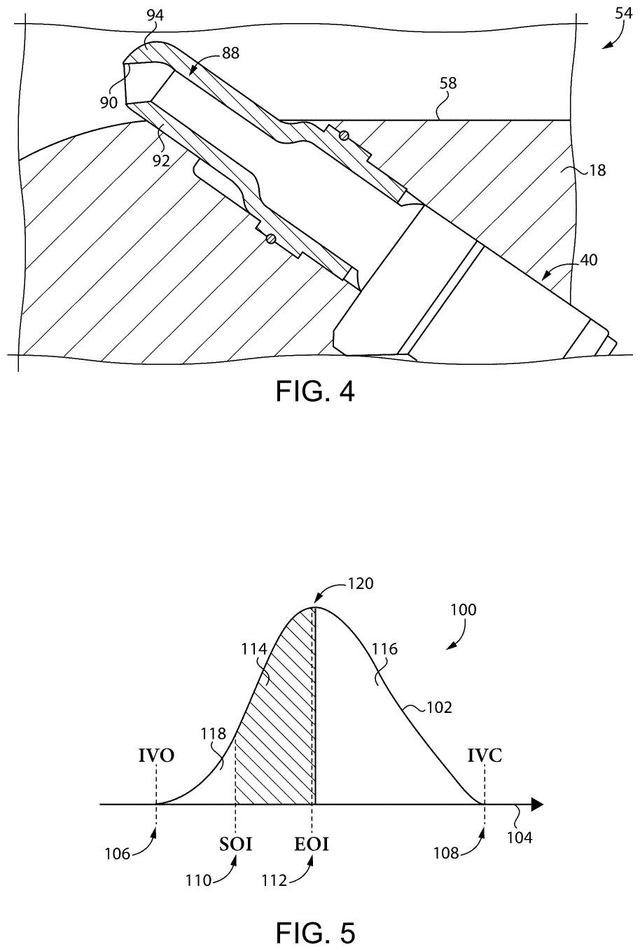

Referring also now to FIG. 4, there is shown another view of cylinder head assembly 54 illustrating second injector 40 extending into second intake port 60. Second injector 40 includes an injector body 86 having a nozzle 88. An outlet 90 is defined by a sleeve 92 receiving injector body 86. In the illustrated embodiment, second injector 40 is equipped with a flow-directing nozzle cap 94 that forms outlet 90. In some embodiments first injector 38 and second injector 40 may be substantially identical but for the application of fuel-directing nozzle cap 94 to one or the other of first injector 38 and second injector 40. In other instances, both first injector 38 and second injector 40 could be equipped with a flow-directing nozzle cap, or neither might include such a cap. In some embodiments, first injector 38 might be a higher flow injector including, for example, a larger outlet opening size, and second injector 40 might be a lower flow injector including, for example, a smaller outlet opening size. First injector 38 and second injector 40 may each include so-called outwardly opening injectors having an outwardly opening valve and a total of one gaseous fuel outlet. It is also contemplated that a capped injector including a flow-directing cap may have a longer injection duration for a given injection amount in at least some instances, as well as being configured to target the injection as desired such as relatively directly into an intake opening connecting to the associated cylinder. A capped injector may be a lower flow one of two injectors, although not necessarily.

As further discussed herein, the present disclosure contemplates injecting a first injection from first injector 38 and a second injection from second injector 40, with the two respective injections together forming a gaseous fuel charge that is admitted to cylinder 16 for combustion therein. In some instances, only one injector and one fuel injection might be used, such as at lower engine load conditions, and both injectors used at higher load conditions. Both injectors might also be used in response to transients where engine load demand changes relatively rapidly. Where two injectors are used, the present disclosure contemplates simultaneous injection timings, overlapped injection timings, and potentially non-overlapped injection timings depending upon application and objectives.

To these ends, injection control unit 50 may be structured to energize first injector 38 and to energize second injector 40 to inject a first injection and a second injection, respectively, of gaseous fuel into intake conduit 22. It will be recalled that intake conduit 22 may include a divided intake conduit, such that the first injection and the second injection are into a respective first intake port 58 and second intake port 60. Injection control unit 50 may be further structured to cause, based on the energizing of first injector 38 and the energizing of second injector 40, the first injection and the second injection to form a gaseous fuel charge in cylinder 16. Each intake valve 62 and 64 may be movable from a closed position at an intake valve opening timing (IVO) toward an open position, and movable from the open position back to the closed position at an intake valve closing timing (IVC). The IVO can be understood as the timing at which intake valve 62,64 first opens, and the IVC can be understood as the timing at which intake valve 62,64 closes. The forming of a gaseous fuel charge in cylinder 16 may occur at a timing between the IVO and the IVC and during an intake stroke of piston 76.

Fueling control unit 50 may be further structured to cause the gaseous fuel charge to be admitted into cylinder 16 sandwiched between a leading cooling flow and a trailing purging flow of pressurized intake air. Admitting most if not all of the gaseous fuel to be combusted in an engine cycle by the time, and typically before, piston 76 reaches its bottom-dead-center position provides for sufficient time and suitable in-cylinder conditions for optimal fuel-air mixing. The leading cooling flow can assist in cooling cylinder 16 somewhat in advance of the admission of the gaseous fuel whilst the trailing purging flow can help prevent residual gaseous fuel from remaining in or migrating back into intake conduit 22. In view of the present disclosure it will be appreciated that the strategies disclosed herein may provide advantages over attempting to achieve similar effects using a single fuel injector.

In particular, a given fuel injector may have limitations in certain conditions, such as at lower flow or at higher flow. An injector optimized to operate reliably and precisely at lower flow, lower engine load conditions, may not be capable of delivering large enough fuel amounts at higher load conditions. Such limitations can be compounded where all of the fuel needs to be admitted into the cylinder while the intake valve is open given the relatively short crank angle timing window. Analogously, an injector optimized to operate reliably and precisely at higher flow, higher engine load conditions, might theoretically provide enough fuel for higher engine power output, but may have fuel delivery stability problems at lower loads. Further, it is believed that injecting the gaseous fuel from two separate injectors and through separate intake ports supplying the same cylinder may contribute to enhanced fuel-air mixing over what might be observed utilizing a single injector in a single intake port.

Referring also now to FIG. 5, there is shown a graph 100 illustrating engine events and states. Graph 100 shows intake valve position at numeral 102 and varying between the IVO 106 and the IVC 108 over time 104. The gaseous fuel charge is shown at 114 sandwiched between the leading cooling flow 118 and the trailing purging flow 116. A start of injection (SOI) is shown at numeral 110, and an end of injection (EOI) is shown at numeral 112. It will be recalled the two fuel injections may have the same SOI timing and the same EOI timing, although the present disclosure is not thereby limited and one or both of the SOI timing and the EOI timing might vary between the respective injections. The SOI as discussed herein means the earliest start of either of two injections, and the EOI means the later end of either of the two injections.

It can also be noted from FIG. 5 that the SOI 110 occurs after the IVO 106, and the EOI 112 occurs before the IVC 108. At least a majority of the gaseous fuel charge 114 may be admitted during the approximate first half of an intake valve open duration from the IVO to the IVC. Further, in an implementation a majority of the gaseous fuel charge 114 is admitted prior to a max flow timing 120 of the respective intake valve. The EOI 112 may occur at about the max flow timing 120 in some embodiments. A combined injection duration of the first injection and the second injection of about 30% or less of the intake valve open duration between the IVO 106 and the IVC 108 may contribute to obtaining optimal results. The trailing purging flow 116 having a flow duration that is about 45% or greater of the intake valve open duration may likewise contribute to obtaining optimal results. As used herein the term “about” should be understood to mean generally or approximately, as would be understood by a person of ordinary skill in the gaseous engine system field, such as within measurement error, conventional rounding, or another tolerance that would be routinely applied.

### INDUSTRIAL APPLICABILITY

Referring to the drawings generally, operating engine 12 can include moving intake valve 62, 64 from a closed position to an open position to fluidly connect cylinder 16 in engine 12 to intake conduit 20 feeding pressurized intake air. Operating engine 12 can further include injecting gaseous fuel into intake conduit 20 in a first injection from first injector 38, and injecting gaseous fuel into intake conduit 20 in a second injection from second injector 40. The gaseous fuel of the first injection and the gaseous fuel of the second injection can be admitted into cylinder 16 from intake conduit 20 to form a gaseous fuel charge of the admitted gaseous fuel in cylinder 16 between the IVO 106 and the IVC 108.

With the fuel charge formed in the cylinder during an intake stroke of piston 76, once piston 76 passes the bottom-dead-center position piston 76 will begin a compression stroke moving toward the top-dead-center position compressing the mixture of fuel and pressurized air therein. At an appropriate timing sparkplug 68 is energized to trigger ignition and combustion of the gaseous fuel in cylinder 16.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A gaseous fuel engine system comprising:
an engine including a cylinder block forming a cylinder, a cylinder head forming an exhaust conduit, and an intake conduit for receiving a feed of pressurized air, and an intake valve movable from a closed position at an intake valve opening timing (IVO), and to the closed position at an intake valve closing timing (IVC);
a fuel system including a gaseous fuel supply containing a gaseous fuel, a first injector coupled to the intake conduit, and a second injector coupled to the intake conduit; and
an injection control unit structured to:
energize the first injector and energize the second injector to inject a first injection and a second injection, respectively, of the gaseous fuel into the intake conduit; and
cause, based on the energizing of the first injector and the energizing of the second injector, the first injection and the second injection to form a gaseous fuel charge in the cylinder at a timing between the IVO and the IVC.

2. The gaseous fuel engine system of claim 1 wherein the intake conduit includes a divided intake conduit forming two intake ports extending to the cylinder.

3. The gaseous fuel engine system of claim 2 wherein each of the first injector and the second injector is arranged to inject the gaseous fuel directly into a respective one of the two intake ports.

4. The gaseous fuel engine system of claim 3 wherein the first injector includes a higher flow injector, and the second injector includes a lower flow injector.

5. The gaseous fuel engine system of claim 3 wherein one of the first injector or the second injector includes a flow-directing nozzle cap.

6. The gaseous fuel engine system of claim 1 wherein the cylinder is one of a plurality of cylinders formed in the cylinder block, and the cylinder head forms a common air admission cavity fluidly connected to a plurality of intake conduits for receiving the feed of pressurized air and each extending to one of the plurality of cylinders.

7. The gaseous fuel engine system of claim 1 wherein the gaseous fuel supply contains a gaseous hydrogen fuel.

8. The gaseous fuel engine system of claim 1 wherein the fueling control unit is further structured to cause the gaseous fuel charge to be admitted into the cylinder sandwiched between a leading cooling flow and a trailing purging flow of the pressurized air.

9. The gaseous fuel engine system of claim 8 wherein a start of injection timing occurs after the IVO, and a majority of the gaseous fuel charge is admitted prior to a max flow timing of the intake valve.

10. The gaseous fuel engine system of claim 9 wherein an end of injection timing occurs at about the max flow timing.

11. The gaseous fuel engine system of claim 8 wherein a combined injection duration of the first injection and the second injection is about 30% or less of an intake valve open duration between the IVO and the IVC, and the trailing purging flow has a flow duration that is about 45% or greater of the intake valve open duration.

12. A method of operating an engine comprising:
moving an intake valve in an engine from a closed position to an open position to fluidly connect a cylinder in the engine to an intake conduit feeding pressurized intake air;
injecting a gaseous fuel into the intake conduit in a first injection from a first injector;
injecting a gaseous fuel into the intake conduit in a second injection from a second injector;
admitting the gaseous fuel of the first injection and the gaseous fuel of the second injection from the intake conduit into the cylinder;
forming a gaseous fuel charge of the admitted gaseous fuel in the cylinder between an intake valve opening timing and an intake valve closing timing; and
combusting the gaseous fuel charge in the cylinder.

13. The method of claim 12 wherein the gaseous fuel includes a gaseous hydrogen fuel, and the admitting the gaseous fuel includes admitting the gaseous fuel sandwiched between a leading cooling flow and a trailing purging flow of the pressurized intake air.

14. The method of claim 13 wherein the trailing purging flow has a flow duration that is about 45% or greater of an intake valve open duration.

15. The method of claim 13 wherein a combined injection duration of the first injection and the second injection is about 30% or less of an intake valve open duration.

16. The method of claim 13 wherein an end of injection timing occurs at about a max flow timing of the intake valve.

17. The method of claim 12 wherein the intake conduit includes a divided intake conduit forming two intake ports extending to two intake openings to the cylinder.

18. The method of claim 17 wherein the first injector and the second injector include port-injectors each arranged to inject the gaseous fuel directly into a respective one of the two intake ports.

19. A cylinder head assembly for a gaseous fuel engine comprising:
a cylinder head forming a plurality of exhaust conduits, a plurality of intake conduits, and a common air admission cavity arranged to feed pressurized air to the plurality of intake conduits;
at least one of the plurality of intake conduits including a divided intake conduit forming a first intake port and a second intake port together arranged to feed the pressurized air to one of a plurality of cylinders in a gaseous fuel engine;
a first intake valve and a second intake valve supported in the cylinder head and arranged to open and close, respectively, the first intake port and the second intake port; and
a first injector and a second injector supported in the cylinder head and arranged to inject a gaseous fuel into the first intake port and the second intake port, respectively.

20. The cylinder head assembly of claim 19 further comprising a fuel supply containing a gaseous hydrogen fuel fluidly connected to the first injector and the second injector, and at least one of the first injector or the second injector including a flow-directing nozzle cap.
